(19) United States
(12) Patent Application Publication
(10) Pub. No.: US 2024/0389122 A1
(43) Pub. Date: Nov. 21, 2024

(54) RESOURCE SELECTION FOR DYNAMICALLY SHARED SIDELINK CHANNELS WITH MIXED NUMEROLOGIES

(71) Applicant: QUALCOMM Incorporated, San Diego, CA (US)

(72) Inventors: Sourjya DUTTA, San Diego, CA (US); Qing LI, Princeton Junction, NJ (US)

(21) Appl. No.: 18/614,338

(22) Filed: Mar. 22, 2024

Related U.S. Application Data
(60) Provisional application No. 63/503,444, filed on May 19, 2023.

(51) Int. Cl. H04W 72/40; H04L 27/26; H04W 72/02; H04W 72/0446

(52) U.S. Cl. CPC H04W 72/40; H04L 27/26025; H04W 72/02; H04W 72/0446

(57) ABSTRACT

Various aspects of the present disclosure generally relate to wireless communication. In some aspects, a transmitting user equipment (UE) (Tx UE) may receive a co-channel coexistence sidelink configuration for identifying and selecting a sidelink resource of a first network based, at least in part, on whether the sidelink resource of the first network occurs during a subframe of a sidelink resource of a second network. The Tx UE may transmit a sidelink message to a receiving UE in accordance with the co-channel coexistence sidelink configuration. Numerous other aspects are described.

### CROSS-REFERENCE TO RELATED APPLICATION

This patent application claims priority to U.S. Provisional Patent Application No. 63/503,444, filed on May 19, 2023, entitled “RESOURCE SELECTION FOR DYNAMICALLY SHARED SIDELINK CHANNELS WITH MIXED NUMEROLOGIES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for resource selection for dynamically shared sidelink channels with mixed numerologies.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a transmitting user equipment (Tx UE) for wireless communication. The Tx UE may include one or more memories and one or more processors coupled to the one or more memories. The one or more processors may be configured to receive a co-channel coexistence sidelink configuration for identifying and selecting a sidelink resource of a first network based, at least in part, on whether the sidelink resource of the first network occurs during a subframe of a sidelink resource of a second network. The one or more processors may be configured to transmit a sidelink message to a receiving UE in accordance with the co-channel coexistence sidelink configuration.

Some aspects described herein relate to a network node for wireless communication. The network node may include one or more memories and one or more processors coupled to the one or more memories. The one or more processors may be configured to transmit a co-channel coexistence sidelink configuration for configuring a Tx UE to identify and select a sidelink resource of a first network based, at least in part, on whether the sidelink resource of the first network occurs during a subframe of a sidelink resource of a second network. The one or more processors may be configured to configure the Tx UE to transmit a sidelink message to a receiving UE in accordance with the co-channel coexistence sidelink configuration.

Some aspects described herein relate to a method of wireless communication performed by a Tx UE. The method may include receiving a co-channel coexistence sidelink configuration for identifying and selecting a sidelink resource of a first network based, at least in part, on whether the sidelink resource of the first network occurs during a subframe of a sidelink resource of a second network. The method may include transmitting a sidelink message to a receiving UE in accordance with the co-channel coexistence sidelink configuration.

Some aspects described herein relate to a method of wireless communication performed by a network node. The method may include transmitting a co-channel coexistence sidelink configuration for configuring a Tx UE to identify and select a sidelink resource of a first network based, at least in part, on whether the sidelink resource of the first network occurs during a subframe of a sidelink resource of a second network. The method may include configuring the Tx UE to transmit a sidelink message to a receiving UE in accordance with the co-channel coexistence sidelink configuration.

Some aspects described herein relate to a non-transitory computer-readable medium that stores a set of instructions for wireless communication by a Tx UE. The set of instructions, when executed by one or more processors of the Tx UE, may cause the Tx UE to receive a co-channel coexistence sidelink configuration for identifying and selecting a sidelink resource of a first network based, at least in part, on whether the sidelink resource of the first network occurs during a subframe of a sidelink resource of a second network. The set of instructions, when executed by one or more processors of the Tx UE, may cause the UE to transmit a sidelink message to a receiving UE in accordance with the co-channel coexistence sidelink configuration.

Some aspects described herein relate to a non-transitory computer-readable medium that stores a set of instructions for wireless communication by a network node. The set of instructions, when executed by one or more processors of the network node, may cause the network node to transmit a co-channel coexistence sidelink configuration for configuring a Tx UE to identify and select a sidelink resource of a first network based, at least in part, on whether the sidelink resource of the first network occurs during a subframe of a sidelink resource of a second network. The set of instructions, when executed by one or more processors of the network node, may cause the network node to configure the Tx UE to transmit a sidelink message to a receiving UE in accordance with the co-channel coexistence sidelink configuration.

Some aspects described herein relate to an apparatus for wireless communication. The apparatus may include means for receiving a co-channel coexistence sidelink configuration for identifying and selecting a sidelink resource of a first network based, at least in part, on whether the sidelink resource of the first network occurs during a subframe of a sidelink resource of a second network. The apparatus may include means for transmitting a sidelink message to a receiving UE in accordance with the co-channel coexistence sidelink configuration.

Some aspects described herein relate to an apparatus for wireless communication. The apparatus may include means for transmitting a co-channel coexistence sidelink configuration for configuring a Tx UE to identify and select a sidelink resource of a first network based, at least in part, on whether the sidelink resource of the first network occurs during a subframe of a sidelink resource of a second network. The apparatus may include means for configuring the Tx UE to transmit a sidelink message to a receiving UE in accordance with the co-channel coexistence sidelink configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of timing and power for wireless communications over networks with mixed numerologies, in accordance with the present disclosure.

FIG. 7 is a diagram illustrating an example of support for different network numerologies over a shared channel, in accordance with the present disclosure.

FIG. 8 is a diagram illustrating examples associated with resource selection and grouping in accordance with a co-channel coexistence sidelink configuration, in accordance with the present disclosure.

FIG. 9 is a diagram illustrating an example associated with resource selection for sidelink communications via a co-channel coexistence configuration, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In the context of 4G Long Term Evolution (LTE) and 5G New Radio (NR), the term “sidelink” refers to a mode of communication where a first user equipment (UE) and a second UE can directly communicate with each other without needing to route their communication through a network node, such as a gNodeB (gNB). This direct communication can be beneficial in situations like vehicle-to-vehicle communication, public safety scenarios, Internet of Things (IoT) networks, or other scenarios where reduced latency and increased reliability are prioritized.

Some UEs may be configured for both NR and LTE sidelink communication, which can have different numerologies. In the context of wireless communication, “numerology” refers to the configuration parameters of a wireless system, such as subcarrier spacing, symbol duration, and cyclic prefix length. Different numerologies can be used to optimize different types of communication. For example, a numerology with wider subcarrier spacing can be used to support higher data rates, while a numerology with narrower spacing can provide broader geographic coverage. The term “mixed numerology” refers to a scenario where different UEs use different numerologies (such as frequencies) at the same time, which can result in interference, particularly when a UE is simultaneously engaged in a sidelink NR communication and an LTE communication, since NR and LTE use different numerologies.

To minimize interference caused by mixed numerologies and allow UEs to share the same radio frequencies for sidelink NR communications and LTE communications, UEs can apply a concept called co-channel coexistence to sidelink communications. In general, the concept of co-channel coexistence allows UEs to employ various techniques that seek to minimize the potential interference between sidelink NR and LTE communications. For example, a receiving UE (Rx UE) may set an automatic gain control (AGC) value for LTE communications at a time when no sidelink NR communications are being received by the Rx UE. Applying that same AGC value when sidelink NR and LTE communications are being received at the Rx UE may result in signal clipping or other performance degradation.

Various aspects relate generally to co-channel coexistence techniques that can be applied to dynamically shared sidelink channels across different radio access networks using different radio access technology (such as NR and LTE). Some aspects more specifically relate to co-channel coexistence techniques that allow for resource selection for dynamically shared sidelink channels with mixed numerologies. In some examples, a UE receives a co-channel coexistence sidelink configuration for identifying and selecting a sidelink resource of a first network (e.g., NR) based, at least in part, on whether the sidelink resource of the first network occurs during a subframe of a sidelink resource of a second network (e.g., LTE). The UE may further apply the co-channel coexistence sidelink configuration and transmit a sidelink message to a receiving UE in accordance with the co-channel coexistence sidelink configuration.

In some examples, a network node configures a transmitting UE to receive a co-channel coexistence sidelink configuration for identifying and selecting a sidelink resource of a first network (e.g., NR) based, at least in part, on whether the sidelink resource of the first network occurs during a subframe of a sidelink resource of a second network (e.g., LTE). The network node may further configure the transmitting UE to apply the co-channel coexistence sidelink configuration and transmit a sidelink message to a receiving UE in accordance with the co-channel coexistence sidelink configuration.

Particular aspects of the subject matter described in this disclosure can be implemented to realize one or more of the following potential advantages. In some examples, by applying the co-channel coexistence sidelink configuration, the transmitting UE may minimize interference that would otherwise be caused by the communications over both networks. In some examples, by having the network node configure the UE to apply the co-channel coexistence sidelink configuration, the described techniques can be used to help the Rx UE set the proper AGC value for sidelink communications over, for example, NR and LTE networks.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

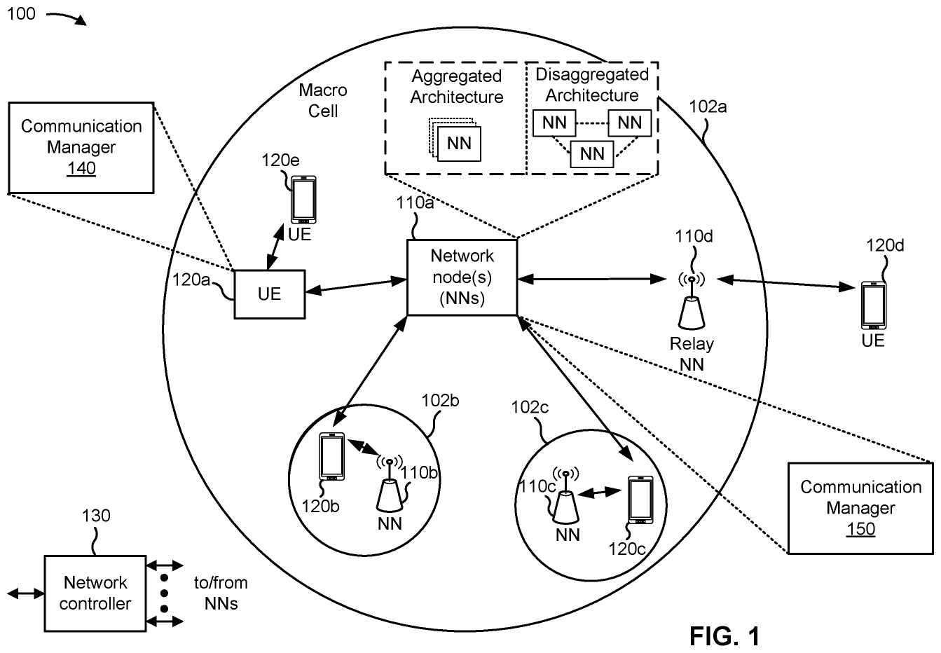

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a co-channel coexistence sidelink configuration for identifying and selecting a sidelink resource of a first network based, at least in part, on whether the sidelink resource of the first network occurs during a subframe of a sidelink resource of a second network; apply the co-channel coexistence sidelink configuration; and transmit a sidelink message to a receiving UE (e.g., a different instance of UE 120) in accordance with the co-channel coexistence sidelink configuration. Additionally, or alternatively, the communication manager 140 may perform one or more other operations described herein.

In some aspects, the network node 110 may include a communication manager 150. As described in more detail elsewhere herein, the communication manager 150 may transmit a co-channel coexistence sidelink configuration for configuring a transmitting UE (such as UE 120) to identify and select a sidelink resource of a first network based, at least in part, on whether the sidelink resource of the first network occurs during a subframe of a sidelink resource of a second network; configure the transmitting UE 120 to apply the co-channel coexistence sidelink configuration; and configure the transmitting UE 120 to transmit a sidelink message to a receiving UE (e.g., a different instance of UE 120) in accordance with the co-channel coexistence sidelink configuration. Additionally, or alternatively, the communication manager 150 may perform one or more other operations described herein.

As discussed in greater detail below, the UE 120 may, at the physical (PHY) and medium access control (MAC) layer, identify and select resources for sidelink communications over a first network (e.g., a 5G network) and a second network (e.g., an LTE network), which may have different numerologies, different RANs, and different RATs. The UE 120 may, in some aspects, coordinate sidelink communications in a way that reduces interference that may be caused by sidelink communications that overlap resources of both the first and second networks.

As indicated above, FIG. 1 is provided as an example. Other examples may differ from what is described with regard to FIG. 1.

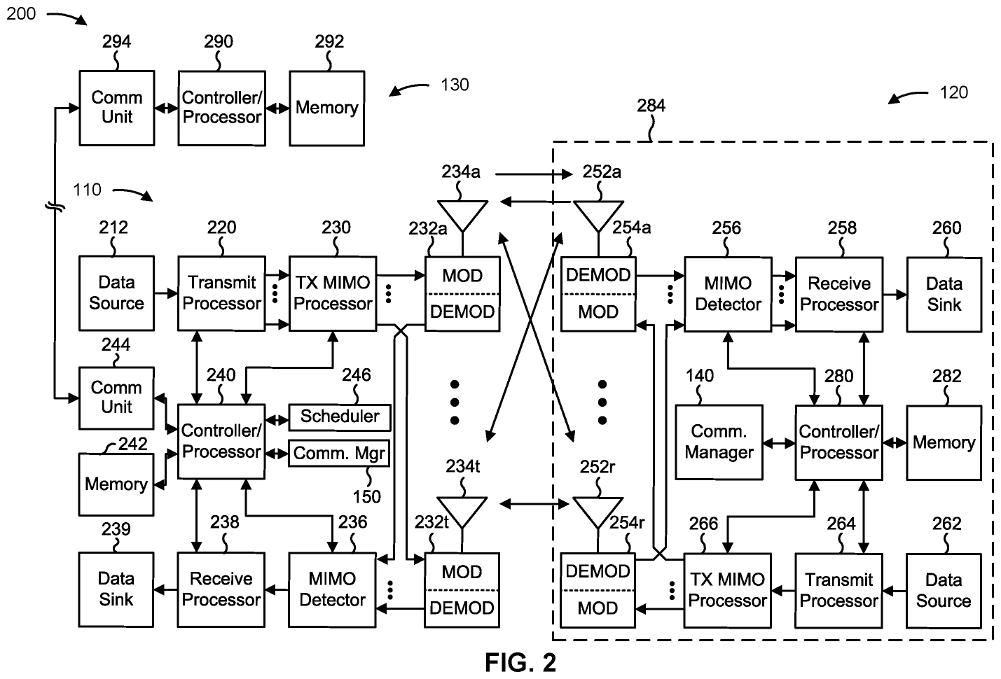

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and May provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

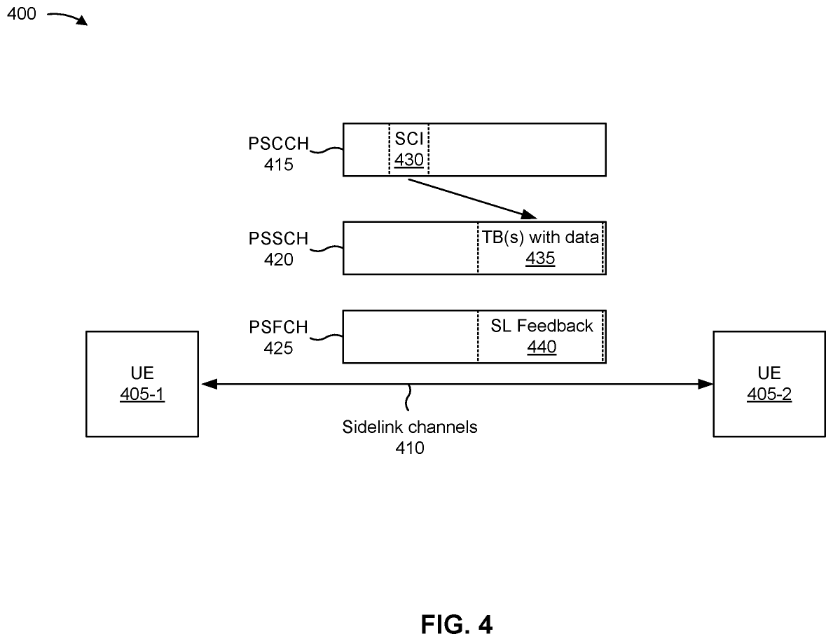

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

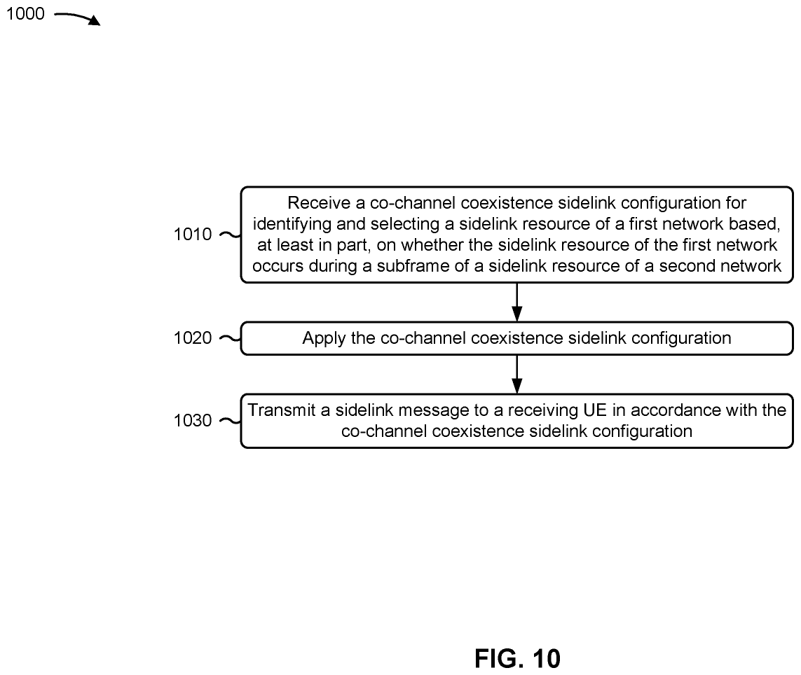

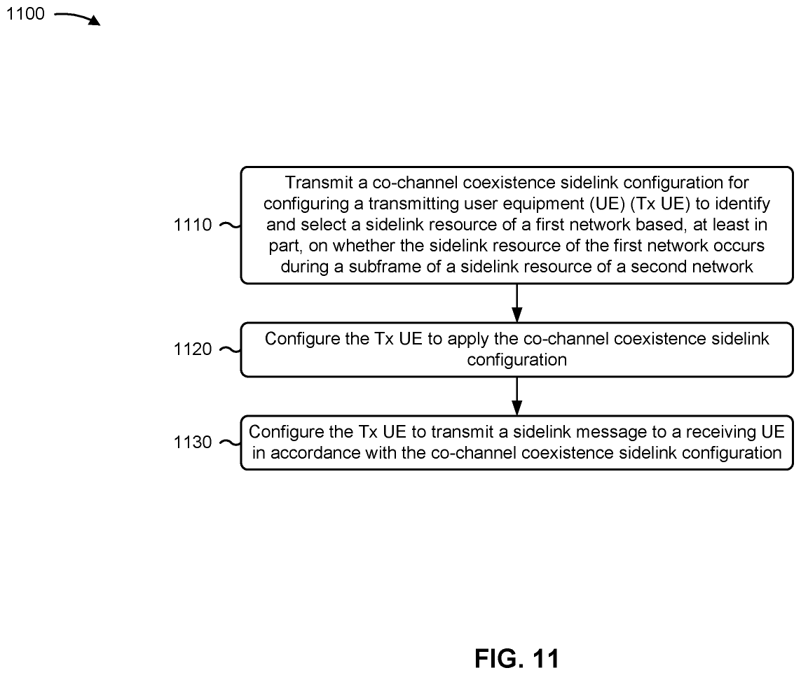

The controller/processor 240 of the network node 110, the controller/processor 280 of the UE 120, and/or any other component(s) of FIG. 2 may perform one or more techniques associated with resource selection for dynamically shared sidelink channels with mixed numerologies, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving a co-channel coexistence sidelink configuration for identifying and selecting a sidelink resource of a first network based, at least in part, on whether the sidelink resource of the first network occurs during a subframe of a sidelink resource of a second network; means for applying the co-channel coexistence sidelink configuration; and/or means for transmitting a sidelink message to a receiving UE in accordance with the co-channel coexistence sidelink configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting a co-channel coexistence sidelink configuration for configuring a transmitting UE (Tx UE) 120 to identify and select a sidelink resource of a first network based, at least in part, on whether the sidelink resource of the first network occurs during a subframe of a sidelink resource of a second network; means for configuring the Tx UE 120 to apply the co-channel coexistence sidelink configuration; and/or means for configuring the Tx UE 120 to transmit a sidelink message to a receiving UE in accordance with the co-channel coexistence sidelink configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

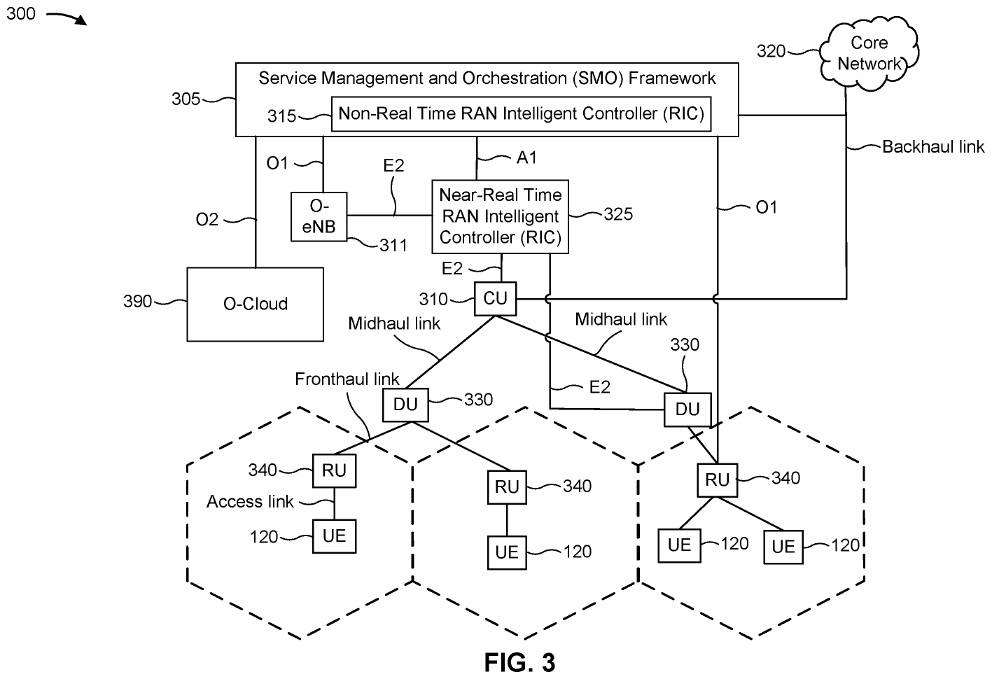

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

In some aspects, the Tx UE 405-1 and the Rx UE 405-2 may be configured to engage in sidelink communications via different RANs configured with different radio access technology. For example, sidelink communications may be via a first network, which may be a 5G NR network, and a second network, which may be a 4G LTE network. The first and second networks may use different numerologies. For example, sidelink communications over the first network may have a subcarrier spacing of 30 kHz, and sidelink communications over the second network may have a subcarrier spacing of 15 kHz. As discussed in greater detail below, the mixed numerologies can cause, for example, the Rx UE 405-2 to sometimes apply an incorrect gain when sidelink transmissions on the first and second networks overlap.

As indicated above, FIG. 4 is provided as an example. Other examples may differ from what is described with respect to FIG. 4.

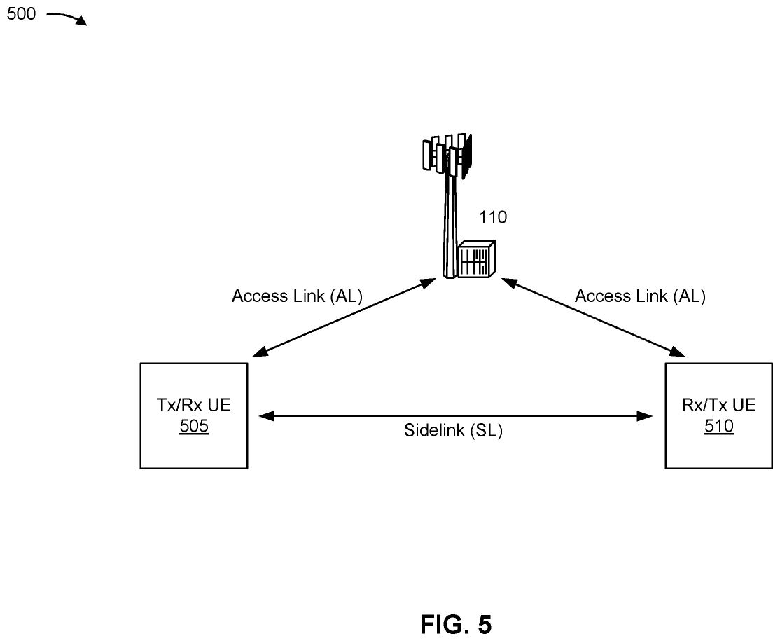

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some aspects, the network node 110 may provide one or both of the Tx/Rx UEs 505, 510 with a co-channel coexistence sidelink configuration that may be used to limit interference and other issues caused by overlapping sidelink communications over the first and second networks.

As indicated above, FIG. 5 is provided as an example. Other examples may differ from what is described with respect to FIG. 5.

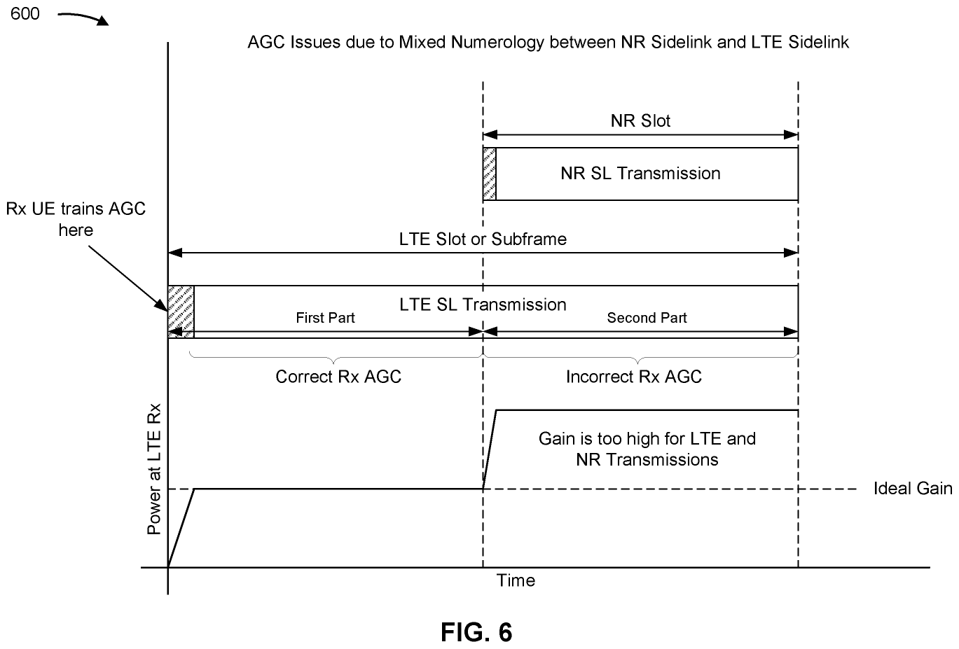

FIG. 6 is a diagram illustrating an example 600 of timing and power for wireless communications over networks with mixed numerologies, in accordance with the present disclosure.

The example 600 presents a scenario where a first network (e.g., 5G NR) sidelink communication and a second network (e.g., 4G LTE) sidelink communication have different numerologies. For example, the first network sidelink communications may use a subcarrier spacing of 30 kHz, while the second network sidelink communications may use a subcarrier spacing of 15 kHz. Accordingly, in this example, the length of the first network sidelink transmission occasion may be half the length of the second network sidelink communication. As explained herein, for co-channel coexistence, the first network sidelink communication may cause interference (in-band emissions) relative to the second network sidelink communication as well as affect the received power at an Rx UE.

The second network sidelink communication may have an OFDM or SC-FDMA symbol, at the beginning of the subframe, that the Rx UE may use to train the AGC value. A similar symbol may occur at the beginning of the slots of the first network sidelink transmissions. With mixed numerologies (e.g., a 30 kHz subcarrier spacing for the first network sidelink communications and a 15 kHz subcarrier spacing for the second network sidelink communications), if the received power changes during the reception of the second network subframe (which may occur due to the first network sidelink communication being shorter than the second network subframe), the gain would be incorrect at the Rx UE and the performance will be degraded.

As shown in the example 600 of FIG. 6, the AGC value is set to provide a gain according to the second network sidelink communication. The AGC value provides the appropriate gain during a first half of the second network sidelink communication. The gain provided by the AGC value is too high, however, when the first network sidelink communication is received during the second half of the second network sidelink communication. This can result in performance degradation at the Rx UE during sidelink communications.

As indicated above, FIG. 6 is provided as an example. Other examples may differ from what is described with respect to FIG. 6.

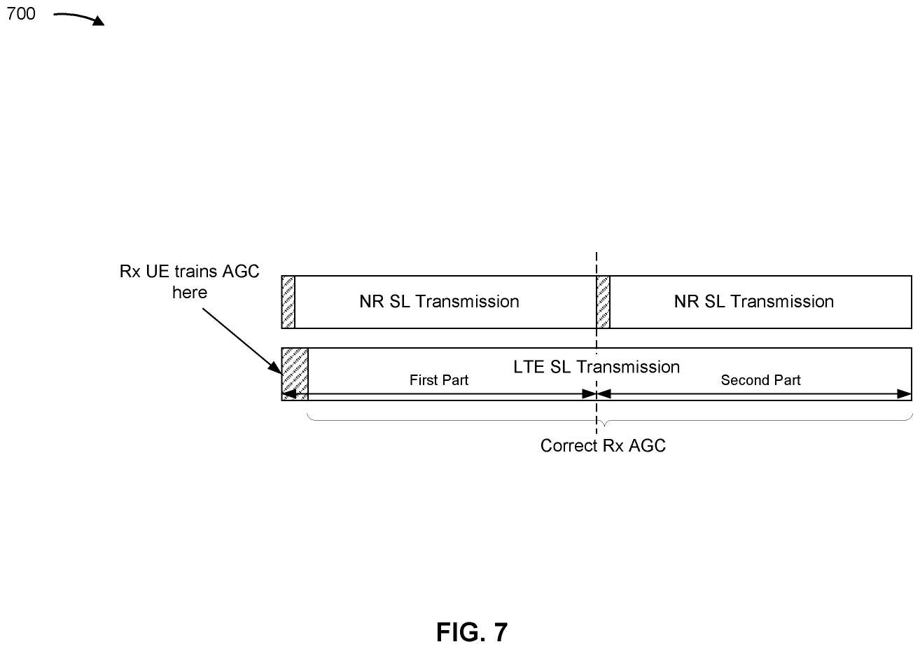

FIG. 7 is a diagram illustrating an example 700 of support for different network numerologies over a shared channel, in accordance with the present disclosure. As shown in example 700, the issue discussed above with reference to FIG. 6 does not occur when consecutive instances (also called “paired slots”) of the first network sidelink communication fully overlap the second network sidelink communication. As in the example 600 of FIG. 6, the Rx UE trains the AGC value at the beginning of the second network sidelink communication. Unlike example 600 of FIG. 6, however, the example 700 of FIG. 7 has a first network sidelink communication occur at the beginning of the second network sidelink communication. Therefore, the AGC value, and ultimately the gain applied, account for both sidelink communications. Therefore, in the example 700 of FIG. 7, the AGC value provides the appropriate gain so long as the consecutive instances of the first network sidelink communications completely overlap the second network sidelink communication. Further, to enable the Rx UE to set an appropriate AGC value at the AGC symbols, the transmitting UE (Tx UE) may need to transmit physical sidelink shared channel (PSSCH) communications, over the paired slot, at similar or equal power levels. In other words, the scenario of example 700 is possible so long as the power levels of consecutive instances of the first network sidelink communications remain relatively constant. Further, transmitting only on the first overlapping transmission occasion may not be detrimental. For example, the Rx UE may train its AGC value as discussed above, but a lower power on the second slot will not lead to unrecoverable losses. As indicated above, FIG. 7 is provided as an example. Other examples may differ from what is described with respect to FIG. 7.

One way to potentially minimize the negative effects of applying an improper AGC value includes strategic resource selection by the Tx UE based on interactions between the PHY layer and the MAC layer of the Tx UE. With respect to resource selection of logical slots by the Tx UE for transmitting sidelink communications on the first network (e.g., NR), the PHY layer may report a set of candidate resources to the MAC layer containing a set of time-frequency resources in a resource window. The set of time-frequency resources may be determined based on a sensing and resource exclusion procedure. From the set of candidate resources, the MAC layer may randomly select resources for a first transmission of a packet. Resources for subsequent retransmissions of the packet may be selected based on the earlier transmission resource, a HARQ processing a feedback timing, and the remaining packet delay budget.

With respect to co-channel coexistence between sidelink communications, on the first and second networks, with mixed numerologies, one physical slot or subframe of the second network could collide with two or more physical slots of the first network during sidelink communication. To minimize the impact and/or risk of that occurring, the MAC layer of the Tx UE associated with the first network sidelink communication may seek to avoid selecting resources that would cause the Tx UE to transmit on any overlapping physical slots within a subframe other than the first physical overlapping slot. Put another way, when only two of the first network sidelink resources overlap the second network sidelink subframe, the Tx UE may be configured to avoid selecting the second of the two overlapping first network sidelink resources unless the first of the two overlapping first network sidelink resources is also selected. When four of the first network sidelink resources overlap the second network sidelink subframe, the Tx UE may be configured to avoid selecting the second, third, and/or fourth network sidelink resources of the overlapping first network sidelink resources unless the first of the four overlapping first network sidelink resources is also selected. In these examples, and as discussed in further detail below, the MAC layer of the Tx UE may receive an indication of whether a first network sidelink resource in a set associated with a first physical slot or a second (or later) physical slot is overlapping with the second network sidelink subframe.

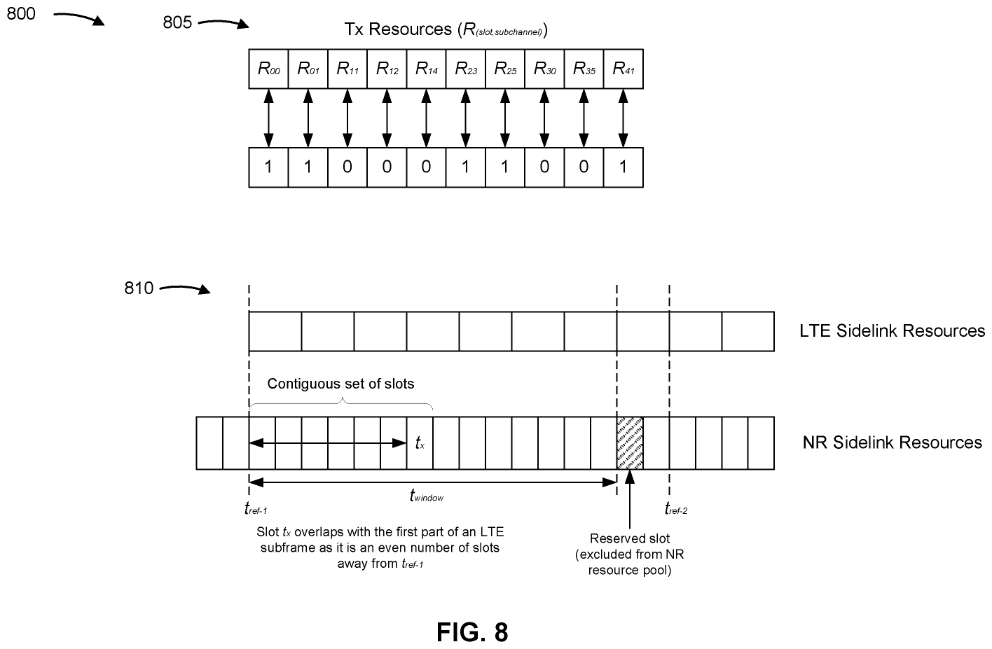

FIG. 8 is a diagram illustrating examples 800 associated with resource selection and grouping in accordance with a co-channel coexistence sidelink configuration, in accordance with the present disclosure. In the examples 800, the PHY layer of the Tx UE indicates to the MAC layer of the Tx UE which resources of the first network occur during a subframe of the second network.

In a first example 805, the PHY layer of the Tx UE may indicate, to the MAC layer of the Tx UE, whether the resource is in a slot that overlaps with the first part of the subframe/slot of the second network or overlaps with the second part of the subframe/slot of the second network. In some aspects, the indication may be a single bit indicator where the indicator is set to, for example, 1 if the resource is on a slot that overlaps with the first part of the subframe, and set to 0 otherwise. Alternatively, in some aspects, the PHY layer of the Tx UE may send, to the MAC layer of the Tx UE, two separate sets of transmission resources. A first set of resources may contain available resources that overlap with the first part of the subframe of the second network, and a second set of resources may contain available resources that overlap with the second part of the subframe of the second network.

In a second example 810, the PHY layer of the Tx UE may indicate, to the MAC layer of the Tx UE, a reference slot (e.g., the NR sidelink resource beginning at time t_{ref-1}) and time window (t_{window}) corresponding to a first subset of candidate resources, where the time window contains contiguous physical slots associated with the first subset of candidate resources. The reference slot may be mapped to a slot of the first network, which may be a first physical slot in a subframe overlapping with a sidelink subframe of the second network. The MAC layer of the Tx UE, in the time window provided, may determine a resource to be in the first or the second overlapping slot based on its distance (in time) from the reference slot. For example, the MAC layer may start a 1-bit counter from the reference slot with value of “1” for the first overlapping slot, then set a bit to a value of “0” for the second overlapping slot, then set a bit to a value of “1” for the first overlapping slot, and so on. In one aspect, at the expiry of the time window, the MAC layer may expect and/or request a new reference slot (e.g., the slot at time T_{tref-2}) and time window associated with a second subset of the set of candidate resources from the PHY layer. Alternatively, in some aspects, the PHY layer may provide, to the MAC layer, a set of reference slots and associated time windows associated with an entirety of a set of set candidate resources.

Alternatively, in some aspects, the PHY layer may indicate, to the MAC layer, whether the first slot for the set of candidate resources overlaps with the first or second physical slot within a subframe. If so, the MAC layer may map the set of candidate resources to the first or second physical slot, respectively, within each subframe based on the slot bit map for a resource pool.

With the resources identified, the MAC layer may select resources for transmission of sidelink communications via the first network. In some aspects, the MAC layer of the Tx UE may select resources for transmission only from the set of resources that are in the slots overlapping with the first part of the subframe of the second network. For example, the MAC layer may select resources so that no transmission occurs on the resources that overlap the second part of the subframe of the second network. Rather, the MAC layer may select resources that facilitate sidelink transmissions only on the first physical slot within a subframe of the second network.

Alternatively, in some aspects, the MAC layer may select resources to transmit a same packet and/or a transport block (TB) on consecutive overlapping slots, where the resource of a first transmission is randomly selected from the set of resources in slots that overlap with the first part of the subframe of the first network (e.g., a first physical slot in a subframe). Further, the MAC layer may select resources in subsequent physical slots within the same subframe of the second network for a re-transmission (e.g., blind retransmission) of the TB if resources are available in that slot for sidelink transmissions over the first network.

Alternatively, in some aspects, the MAC layer may transmit different packets or a TB on consecutive overlapping slots where the mth (m>0) transmission of the first TB or packet is scheduled on slot k (e.g., the first physical slot of a subframe of the second network), the nth (n>0) transmission of the second TB or packet is scheduled on slot k+1 (e.g., the second physical slot of the same subframe of the second network), and when sufficient resources are available in slot k+1 for the transmission of the second TB or packet.

As indicated above, FIG. 8 is provided as an example. Other examples may differ from what is described with respect to FIG. 8.

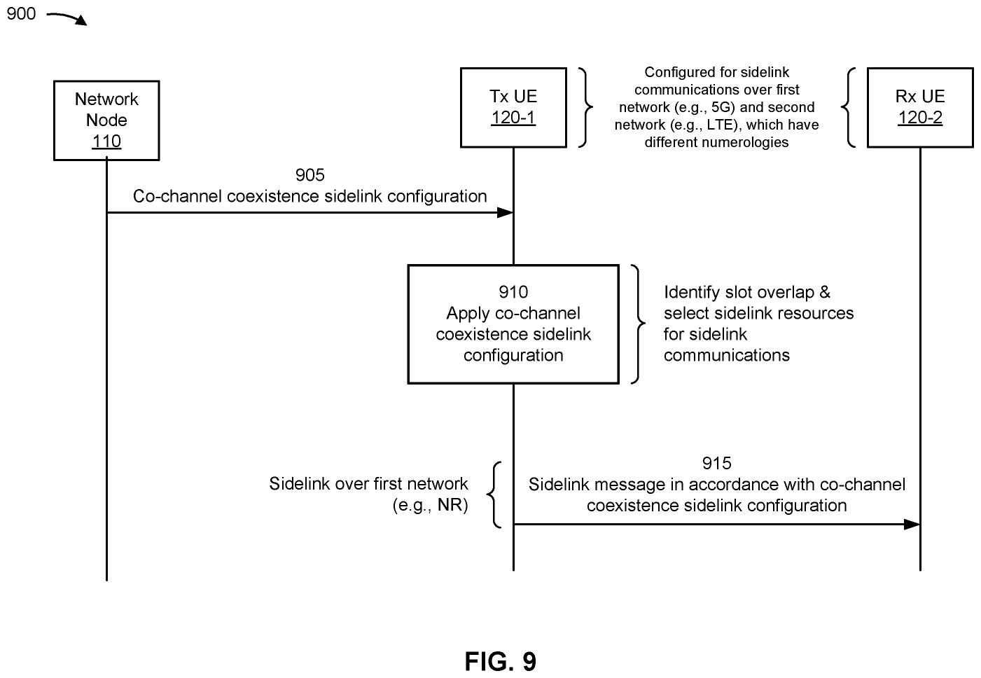

FIG. 9 is a diagram illustrating an example 900 associated with resource selection for sidelink communications via a co-channel coexistence configuration, in accordance with the present disclosure. As shown in FIG. 9, a network node 110 and a Tx UE 120-1 and an Rx UE 120-2 may communicate with one another. For example, the network node 110 and the Tx UE 120-1 may communicate via a Uu interface and the Tx UE 120-1 and the Rx UE 120-2 may communicate via a sidelink (e.g., PC5) interface.

As shown by reference number 905, the network node 110 may transmit, and the Tx UE 120-1 may receive, a co-channel coexistence sidelink configuration. When applied by the Tx UE 120-1, the co-channel coexistence sidelink configuration may cause the Tx UE 120-1 to identify and select sidelink resources of a first network (e.g., a 5G NR network) based, at least in part, on whether the sidelink resource of the first network occurs during a subframe of a sidelink resource of a second network (e.g., an LTE network). In some aspects, the co-channel coexistence sidelink configuration may apply to sidelink communications between the Tx UE 120-1 and the Rx UE 120-2 when the first network and the second network are associated with different numerologies. For example, the first network may be associated with a first numerology and the second network may be associated with a second numerology, which may be different from the first numerology. By transmitting the co-channel coexistence sidelink configuration, the network node 110 configures the Tx UE 120-1 to perform actions, discussed herein, in accordance with the co-channel coexistence sidelink configuration.

As shown by reference number 910, the Tx UE 120-1 may apply the co-channel coexistence sidelink configuration. Applying the co-channel coexistence sidelink configuration may include the Tx UE 120-1 identifying that one or more sidelink resources of the first network would at least partially overlap the subframe of the sidelink resource of the second network. In some aspects, identifying that the sidelink resource of the first network at least partially overlaps the subframe of the sidelink resource of the second network includes determining that the sidelink resource of the first network occurs during a first part or a second part of the subframe of the sidelink resource of the second network. For example, in the example 600 of FIG. 6, a sidelink resource of the first network (NR SL Transmission) overlaps the second part of the subframe of the sidelink resource of the second network (LTE SL Transmission). In the example 700 of FIG. 7, one sidelink resource of the first network overlaps the first part of the subframe of the sidelink resource of the second network and another sidelink resource of the first network overlaps the second part of the subframe of the sidelink resource of the second network. In some aspects, determining whether the sidelink resource of the first network occurs during the first part of the subframe of the sidelink resource of the second network or the second part of the subframe of the sidelink resource of the second network is based, at least in part, on a slot bit map for a resource pool. For example, the PHY layer of the Tx UE 120-1 may indicate to the MAC layer of the Tx UE 120-1 if the first slot for the set of candidate resources is the first or second physical slot within a subframe of the second network, and the MAC layer may map the set of candidate resources to the first or second physical slot within each subframe based on the slot bit map for the resource pool, as discussed above with respect to FIG. 8.

In some aspects, the Tx UE 120-1 may identify that the sidelink resource of the first network at least partially overlaps the subframe of the sidelink resource of the second network by setting a first bit indicating that the sidelink resource of the first network occurs during the first part of the subframe of the sidelink resource of the second network. In some aspects, the Tx UE 120-1 may identify that the sidelink resource of the first network at least partially overlaps the subframe of the sidelink resource of the second network by setting a second bit indicating that the sidelink resource of the first network occurs during the second part of the subframe of the sidelink resource of the second network.

Alternatively, in some aspects, the Tx UE 120-1 may assign the sidelink resource of the first network to a first set of resources as a result of determining that the sidelink resource of the first network occurs during a first part of the subframe of the sidelink resource of the second network. In some aspects, the Tx UE 120-1 may assign the sidelink resource of the first network to a second set of resources as a result of determining that the sidelink resource of the first network occurs during a second part of the subframe of the sidelink resource of the second network.

In another possible alternative, in some aspects, the Tx UE 120-1 may assign the sidelink resource of the first network to a first set of resources as a result of determining that the sidelink resource of the first network is among a contiguous set of sidelink resources (such as those shown in example 810 of FIG. 8) relative to a reference resource (such as the slot at time t_{ref-1} in example 810 of FIG. 8) that occurs during a first part of the subframe of the sidelink resource of the second network, or assigning the sidelink resource of the first network to a second set of resources as a result of determining that the sidelink resource of the first network is not among a contiguous set of sidelink resources relative to a reference resource that occurs during the first part of the subframe of the sidelink resource of the second network. In some aspects, determining that the sidelink resource of the first network is among the contiguous set of sidelink resources relative to the reference resource includes determining that the sidelink resource of the first network occurs within a first time window (such as t_{window} shown in example 810 of FIG. 8) associated with the contiguous set of sidelink resources, the first time window beginning with the reference resource. Alternatively, in some aspects, determining that the sidelink resource of the first network is among the contiguous set of sidelink resources relative to the reference resource includes, after an expiry of the first time window, receiving a second time window associated with a different reference resource (such as the slot at time t_{ref-2} shown in example 810 of FIG. 8) and a different contiguous set of sidelink resources relative to the different reference resource.

In some aspects, applying the co-channel coexistence sidelink configuration includes the MAC layer of the Tx UE 120-1 selecting the sidelink resource of the first network based, at least in part, on the sidelink resource of the first network occurring during a first part of the subframe of the sidelink resource of the second network. Alternatively, in some aspects, applying the co-channel coexistence sidelink configuration includes the MAC layer of the Tx UE 120-1 selecting the sidelink resource of the first network based, at least in part, on the sidelink resource of the first network occurring during a first part of the subframe of the sidelink resource of the second network, or the sidelink resource of the first network being among a contiguous set of sidelink resources relative to a reference resource that occurs during the first part of the subframe of the sidelink resource of the second network. For example, in some aspects, the MAC layer of the Tx UE 120-1 may select a physical slot associated with the sidelink resource of the first network from among the contiguous set of sidelink resources for retransmission. Alternatively, in some aspects, the MAC layer of the Tx UE 120-1 may schedule a transmission of a first packet during a first slot and schedule a transmission of a second packet during a second slot, the second slot being part of a same subframe of the first network as the first slot.

As shown by reference number 915, the Tx UE 120-1 may transmit, and the Rx UE 120-2 may receive, a sidelink message in accordance with the co-channel coexistence sidelink configuration. The sidelink message may be transmitted to the Rx UE 120-2 via a sidelink interface, such as the PC5 interface, via the first network.

With the foregoing approach, the Tx UE 120-1 may select resources for sidelink communications over the first (e.g., NR) network that will not significantly interfere with sidelink communications over the second (e.g., LTE) network, thereby improving user experience and network performance.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the Tx UE (e.g., UE 120) performs operations associated with resource selection for dynamically shared sidelink channels with mixed numerologies.

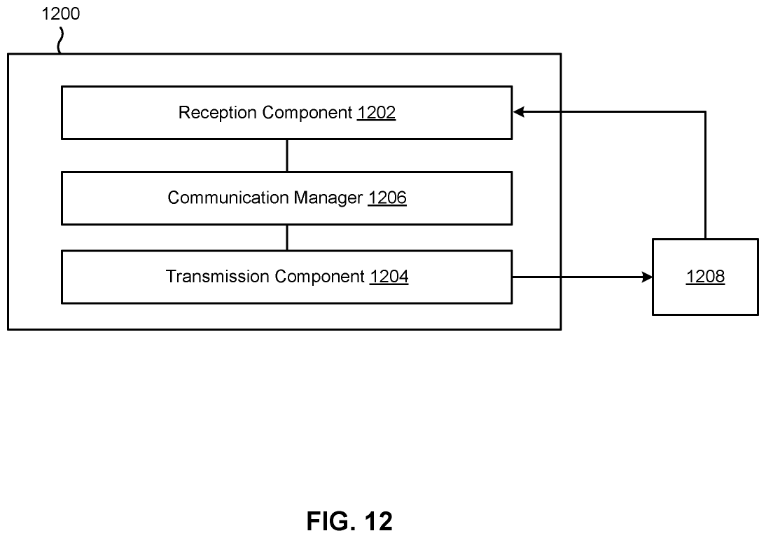

As shown in FIG. 10, in some aspects, process 1000 may include receiving a co-channel coexistence sidelink configuration for identifying and selecting a sidelink resource of a first network based, at least in part, on whether the sidelink resource of the first network occurs during a subframe of a sidelink resource of a second network (block 1010). For example, the Tx UE (e.g., using reception component 1202 and/or communication manager 1206, depicted in FIG. 12) may receive a co-channel coexistence sidelink configuration for identifying and selecting a sidelink resource of a first network based, at least in part, on whether the sidelink resource of the first network occurs during a subframe of a sidelink resource of a second network, as described above with regard to reference number 905 of FIG. 9.

As further shown in FIG. 10, in some aspects, process 1000 may include applying the co-channel coexistence sidelink configuration (block 1020). For example, the Tx UE (e.g., using communication manager 1206, depicted in FIG. 12) may apply the co-channel coexistence sidelink configuration, as described above with regard to reference number 910 of FIG. 9.

As further shown in FIG. 10, in some aspects, process 1000 may include transmitting a sidelink message to an Rx UE in accordance with the co-channel coexistence sidelink configuration (block 1030). For example, the Tx UE (e.g., using transmission component 1204 and/or communication manager 1206, depicted in FIG. 12) may transmit a sidelink message to an Rx UE in accordance with the co-channel coexistence sidelink configuration, as described above with regard to reference number 915 of FIG. 9.

Process 1000 may include additional aspects, such as any single aspect or any combination of aspects described below and/or in connection with one or more other processes described elsewhere herein.

In a first aspect, the first network is associated with a first numerology and the second network is associated with a second numerology different from the first numerology.

In a second aspect, alone or in combination with the first aspect, applying the co-channel coexistence sidelink configuration includes identifying that the sidelink resource of the first network at least partially overlaps the subframe of the sidelink resource of the second network.

In a third aspect, alone or in combination with one or more of the first and second aspects, identifying that the sidelink resource of the first network at least partially overlaps the subframe of the sidelink resource of the second network includes determining that the sidelink resource of the first network occurs during a first part or a second part of the subframe of the sidelink resource of the second network.

In a fourth aspect, alone or in combination with one or more of the first through third aspects, identifying that the sidelink resource of the first network at least partially overlaps the subframe of the sidelink resource of the second network includes setting a first bit indicating that the sidelink resource of the first network occurs during the first part of the subframe of the sidelink resource of the second network, or setting a second bit indicating that the sidelink resource of the first network occurs during the second part of the subframe of the sidelink resource of the second network.

In a fifth aspect, alone or in combination with one or more of the first through fourth aspects, identifying that the sidelink resource of the first network at least partially overlaps the subframe of the sidelink resource of the second network includes assigning the sidelink resource of the first network to a first set of resources as a result of determining that the sidelink resource of the first network occurs during a first part of the subframe of the sidelink resource of the second network, or assigning the sidelink resource of the first network to a second set of resources as a result of determining that the sidelink resource of the first network occurs during a second part of the subframe of the sidelink resource of the second network.

In a sixth aspect, alone or in combination with one or more of the first through fifth aspects, identifying that the sidelink resource of the first network at least partially overlaps the subframe of the sidelink resource of the second network includes assigning the sidelink resource of the first network to a first set of resources as a result of determining that the sidelink resource of the first network is among a contiguous set of sidelink resources relative to a reference resource that occurs during a first part of the subframe of the sidelink resource of the second network, or assigning the sidelink resource of the first network to a second set of resources as a result of determining that the sidelink resource of the first network is not among a contiguous set of sidelink resources relative to a reference resource that occurs during the first part of the subframe of the sidelink resource of the second network.

In a seventh aspect, alone or in combination with one or more of the first through sixth aspects, determining that the sidelink resource of the first network is among the contiguous set of sidelink resources relative to the reference resource includes determining that the sidelink resource of the first network occurs within a first time window associated with the contiguous set of sidelink resources, the first time window beginning with the reference resource.

In an eighth aspect, alone or in combination with one or more of the first through seventh aspects, determining that the sidelink resource of the first network is among the contiguous set of sidelink resources relative to the reference resource includes, after an expiry of the first time window, receiving a second time window associated with a different reference resource and a different contiguous set of sidelink resources relative to the different reference resource.

In a ninth aspect, alone or in combination with one or more of the first through eighth aspects, determining whether the sidelink resource of the first network occurs during the first part of the subframe of the sidelink resource of the second network or the second part of the subframe of the sidelink resource of the second network includes determining whether the sidelink resource of the first network occurs during the first part of the subframe of the sidelink resource of the second network or the second part of the subframe of the sidelink resource of the second network based, at least in part, on a slot bit map for a resource pool.

In a tenth aspect, alone or in combination with one or more of the first through ninth aspects, applying the co-channel coexistence sidelink configuration includes selecting, via a MAC layer, the sidelink resource of the first network based, at least in part, on the sidelink resource of the first network occurring during a first part of the subframe of the sidelink resource of the second network.

In an eleventh aspect, alone or in combination with one or more of the first through tenth aspects, applying the co-channel coexistence sidelink configuration includes selecting, via a MAC layer, the sidelink resource of the first network based, at least in part, on the sidelink resource of the first network occurring during a first part of the subframe of the sidelink resource of the second network, or the sidelink resource of the first network being among a contiguous set of sidelink resources relative to a reference resource that occurs during the first part of the subframe of the sidelink resource of the second network.

In a twelfth aspect, alone or in combination with one or more of the first through eleventh aspects, selecting the sidelink resource of the first network based, at least in part, on the sidelink resource of the first network being among the contiguous set of sidelink resources relative to the reference resource that occurs during the first part of the subframe of the sidelink resource of the second network includes selecting a physical slot associated with the sidelink resource of the first network from among the contiguous set of sidelink resources for retransmission.

In a thirteenth aspect, alone or in combination with one or more of the first through twelfth aspects, selecting the sidelink resource of the first network based, at least in part, on the sidelink resource of the first network being among the contiguous set of sidelink resources relative to the reference resource that occurs during the first part of the subframe of the sidelink resource of the second network includes scheduling a transmission of a first packet during a first slot and scheduling a transmission of a second packet during a second slot, the second slot being part of a same subframe of the first network as the first slot.

In a fourteenth aspect, alone or in combination with one or more of the first through thirteenth aspects, the first network and second network are different radio access networks.

In a fifteenth aspect, alone or in combination with one or more of the first through fourteenth aspects, the first network is an NR network and the second network is an LTE network.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with resource selection for dynamically shared sidelink channels with mixed numerologies.

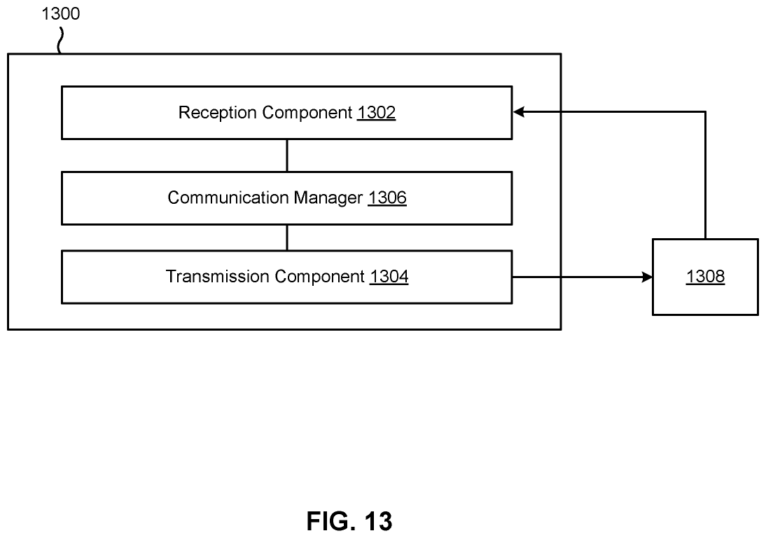

As shown in FIG. 11, in some aspects, process 1100 may include transmitting a co-channel coexistence sidelink configuration for configuring a Tx UE to identify and select a sidelink resource of a first network based, at least in part, on whether the sidelink resource of the first network occurs during a subframe of a sidelink resource of a second network (block 1110). For example, the network node (e.g., using transmission component 1304 and/or communication manager 1306, depicted in FIG. 13) may transmit a co-channel coexistence sidelink configuration for configuring a Tx UE to identify and select a sidelink resource of a first network based, at least in part, on whether the sidelink resource of the first network occurs during a subframe of a sidelink resource of a second network, as described above with reference to reference number 905 of FIG. 9.

As further shown in FIG. 11, in some aspects, process 1100 may include configuring the Tx UE to apply the co-channel coexistence sidelink configuration (block 1120). For example, the network node (e.g., using communication manager 1306, depicted in FIG. 13) may configure the Tx UE to apply the co-channel coexistence sidelink configuration, as described above with reference to reference number 910 of FIG. 9.

As further shown in FIG. 11, in some aspects, process 1100 may include configuring the Tx UE to transmit a sidelink message to an Rx UE in accordance with the co-channel coexistence sidelink configuration (block 1130). For example, the network node (e.g., using communication manager 1306, depicted in FIG. 13) may configure the Tx UE to transmit a sidelink message to an Rx UE in accordance with the co-channel coexistence sidelink configuration, as described above with reference to reference number 915 of FIG. 9.

Process 1100 may include additional aspects, such as any single aspect or any combination of aspects described below and/or in connection with one or more other processes described elsewhere herein.

In a first aspect, the first network is associated with a first numerology and the second network is associated with a second numerology different from the first numerology.

In a second aspect, alone or in combination with the first aspect, configuring the Tx UE to apply the co-channel coexistence sidelink configuration includes configuring the Tx UE to identify that the sidelink resource of the first network at least partially overlaps the subframe of the sidelink resource of the second network.

In a third aspect, alone or in combination with one or more of the first and second aspects, configuring the Tx UE to identify that the sidelink resource of the first network at least partially overlaps the subframe of the sidelink resource of the second network includes configuring the Tx UE to determine whether the sidelink resource of the first network occurs during a first part of the subframe of the sidelink resource of the second network or a second part of the subframe of the sidelink resource of the second network.

In a fourth aspect, alone or in combination with one or more of the first through third aspects, configuring the Tx UE to identify that the sidelink resource of the first network at least partially overlaps the subframe of the sidelink resource of the second network includes configuring the Tx UE to set a first bit indicating that the sidelink resource of the first network occurs during the first part of the subframe of the sidelink resource of the second network or set a second bit indicating that the sidelink resource of the first network occurs during the second part of the subframe of the sidelink resource of the second network.

In a fifth aspect, alone or in combination with one or more of the first through fourth aspects, configuring the Tx UE to identify that the sidelink resource of the first network at least partially overlaps the subframe of the sidelink resource of the second network includes configuring the Tx UE to assign the sidelink resource of the first network to a first set of resources as a result of the Tx UE determining that the sidelink resource of the first network occurs during the first part of the subframe of the sidelink resource of the second network, or assign the sidelink resource of the first network to a second set of resources as a result of the Tx UE determining that the sidelink resource of the first network occurs during the second part of the subframe of the sidelink resource of the second network.

In a sixth aspect, alone or in combination with one or more of the first through fifth aspects, configuring the Tx UE to identify that the sidelink resource of the first network at least partially overlaps the subframe of the sidelink resource of the second network includes configuring the Tx UE to assign the sidelink resource of the first network to a first set of resources as a result of the Tx UE determining that the sidelink resource of the first network is among a contiguous set of sidelink resources relative to a reference resource that occurs during the first part of the subframe of the sidelink resource of the second network, or assign the sidelink resource of the first network to a second set of resources as a result of the Tx UE determining that the sidelink resource of the first network is not among a contiguous set of sidelink resources relative to a reference resource that occurs during the first part of the subframe of the sidelink resource of the second network.

In a seventh aspect, alone or in combination with one or more of the first through sixth aspects, configuring the Tx UE to apply the co-channel coexistence sidelink configuration includes configuring the Tx UE to select the sidelink resource of the first network based, at least in part, on the sidelink resource of the first network occurring during the first part of the subframe of the sidelink resource of the second network.

In an eighth aspect, alone or in combination with one or more of the first through seventh aspects, configuring the Tx UE to apply the co-channel coexistence sidelink configuration includes configuring the Tx UE to select the sidelink resource of the first network based, at least in part, on the sidelink resource of the first network occurring during the first part of the subframe of the sidelink resource of the second network, or the sidelink resource of the first network being among a contiguous set of sidelink resources relative to a reference resource that occurs during the first part of the subframe of the sidelink resource of the second network.

In a ninth aspect, alone or in combination with one or more of the first through eighth aspects, configuring the Tx UE to select the sidelink resource of the first network based, at least in part, on the sidelink resource of the first network being among the contiguous set of sidelink resources relative to the reference resource that occurs during the first part of the subframe of the sidelink resource of the second network includes configuring the Tx UE to select a physical slot associated with the sidelink resource of the first network among the contiguous set of sidelink resources for retransmission.

In a tenth aspect, alone or in combination with one or more of the first through ninth aspects, configuring the Tx UE to select the sidelink resource of the first network based, at least in part, on the sidelink resource of the first network being among the contiguous set of sidelink resources relative to the reference resource that occurs during the first part of the subframe of the sidelink resource of the second network includes configuring the Tx UE to schedule a transmission of a first packet during a first slot and schedule a transmission of a second packet during a second slot, the second slot being part of a same subframe of the first network as the first slot.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a Tx UE, or a Tx UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as an Rx UE or a network node (such as a CU, a DU, an RU, or a base station), using the reception component 1202 and the transmission component 1204.

In some aspects, the apparatus 1200 may be configured to perform one or more operations described herein in connection with FIGS. 4-11. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive a co-channel coexistence sidelink configuration for identifying and selecting a sidelink resource of a first network based, at least in part, on whether the sidelink resource of the first network occurs during a subframe of a sidelink resource of a second network. The communication manager 1206 may apply the co-channel coexistence sidelink configuration. The transmission component 1204 may transmit a sidelink message to a receiving UE in accordance with the co-channel coexistence sidelink configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node 110, or a network node 110 may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit a co-channel coexistence sidelink configuration for configuring a Tx UE to identify and select a sidelink resource of a first network based, at least in part, on whether the sidelink resource of the first network occurs during a subframe of a sidelink resource of a second network. The communication manager 1306 may configure the Tx UE to apply the co-channel coexistence sidelink configuration. The communication manager 1306 may configure the Tx UE to transmit a sidelink message to an Rx UE in accordance with the co-channel coexistence sidelink configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a Tx UE, comprising: receiving a co-channel coexistence sidelink configuration for identifying and selecting a sidelink resource of a first network based, at least in part, on whether the sidelink resource of the first network occurs during a subframe of a sidelink resource of a second network; and transmitting a sidelink message to an Rx UE in accordance with the co-channel coexistence sidelink configuration.

Aspect 2: The method of Aspect 1, wherein the first network is associated with a first numerology and the second network is associated with a second numerology different from the first numerology.

Aspect 3: The method of any of Aspects 1-2, further comprising applying the co-channel coexistence sidelink configuration, wherein applying the co-channel coexistence sidelink configuration includes identifying that the sidelink resource of the first network at least partially overlaps the subframe of the sidelink resource of the second network.

Aspect 4: The method of Aspect 3, wherein identifying that the sidelink resource of the first network at least partially overlaps the subframe of the sidelink resource of the second network includes determining that the sidelink resource of the first network occurs during a first part or a second part of the subframe of the sidelink resource of the second network.

Aspect 5: The method of Aspect 4, wherein identifying that the sidelink resource of the first network at least partially overlaps the subframe of the sidelink resource of the second network includes setting a first bit indicating that the sidelink resource of the first network occurs during the first part of the subframe of the sidelink resource of the second network, or setting a second bit indicating that the sidelink resource of the first network occurs during the second part of the subframe of the sidelink resource of the second network.

Aspect 6: The method of Aspect 4, wherein identifying that the sidelink resource of the first network at least partially overlaps the subframe of the sidelink resource of the second network includes assigning the sidelink resource of the first network to a first set of resources as a result of determining that the sidelink resource of the first network occurs during a first part of the subframe of the sidelink resource of the second network, or assigning the sidelink resource of the first network to a second set of resources as a result of determining that the sidelink resource of the first network occurs during a second part of the subframe of the sidelink resource of the second network.

Aspect 7: The method of Aspect 4, wherein identifying that the sidelink resource of the first network at least partially overlaps the subframe of the sidelink resource of the second network includes assigning the sidelink resource of the first network to a first set of resources as a result of determining that the sidelink resource of the first network is among a contiguous set of sidelink resources relative to a reference resource that occurs during a first part of the subframe of the sidelink resource of the second network, or assigning the sidelink resource of the first network to a second set of resources as a result of determining that the sidelink resource of the first network is not among a contiguous set of sidelink resources relative to a reference resource that occurs during the first part of the subframe of the sidelink resource of the second network.

Aspect 8: The method of Aspect 7, wherein determining that the sidelink resource of the first network is among the contiguous set of sidelink resources relative to the reference resource includes determining that the sidelink resource of the first network occurs within a first time window associated with the contiguous set of sidelink resources, the first time window beginning with the reference resource.

Aspect 9: The method of Aspect 8, wherein determining that the sidelink resource of the first network is among the contiguous set of sidelink resources relative to the reference resource includes, after an expiry of the first time window, receiving a second time window associated with a different reference resource and a different contiguous set of sidelink resources relative to the different reference resource.

Aspect 10: The method of Aspect 4, wherein determining whether the sidelink resource of the first network occurs during the first part of the subframe of the sidelink resource of the second network or the second part of the subframe of the sidelink resource of the second network includes determining whether the sidelink resource of the first network occurs during the first part of the subframe of the sidelink resource of the second network or the second part of the subframe of the sidelink resource of the second network based, at least in part, on a slot bit map for a resource pool.

Aspect 11: The method of any of Aspects 1-10, further comprising applying the co-channel coexistence sidelink configuration, wherein applying the co-channel coexistence sidelink configuration includes selecting, via a medium access control (MAC) layer, the sidelink resource of the first network based, at least in part, on the sidelink resource of the first network occurring during a first part of the subframe of the sidelink resource of the second network.

Aspect 12: The method of any of Aspects 1-11, further comprising applying the co-channel coexistence sidelink configuration, wherein applying the co-channel coexistence sidelink configuration includes selecting, via a medium access control (MAC) layer, the sidelink resource of the first network based, at least in part, on the sidelink resource of the first network occurring during a first part of the subframe of the sidelink resource of the second network, or the sidelink resource of the first network being among a contiguous set of sidelink resources relative to a reference resource that occurs during the first part of the subframe of the sidelink resource of the second network.

Aspect 13: The method of Aspect 12, wherein selecting the sidelink resource of the first network based, at least in part, on the sidelink resource of the first network being among the contiguous set of sidelink resources relative to the reference resource that occurs during the first part of the subframe of the sidelink resource of the second network includes selecting a physical slot associated with the sidelink resource of the first network from among the contiguous set of sidelink resources for retransmission.

Aspect 14: The method of Aspect 12, wherein selecting the sidelink resource of the first network based, at least in part, on the sidelink resource of the first network being among the contiguous set of sidelink resources relative to the reference resource that occurs during the first part of the subframe of the sidelink resource of the second network includes scheduling a transmission of a first packet during a first slot and scheduling a transmission of a second packet during a second slot, the second slot being part of a same subframe of the first network as the first slot.

Aspect 15: The method of any of Aspects 1-14, wherein the first network and second network are different radio access networks.

Aspect 16: The method of any of Aspects 1-15, wherein the first network is an NR network and the second network is an LTE network.

Aspect 17: A method of wireless communication performed by a network node, comprising: transmitting a co-channel coexistence sidelink configuration for configuring a Tx UE to identify and select a sidelink resource of a first network based, at least in part, on whether the sidelink resource of the first network occurs during a subframe of a sidelink resource of a second network; and configuring the Tx UE to transmit a sidelink message to an Rx UE in accordance with the co-channel coexistence sidelink configuration.

Aspect 18: The method of Aspect 17, wherein the first network is associated with a first numerology and the second network is associated with a second numerology different from the first numerology.

Aspect 19: The method of any of Aspects 17-18, further comprising configuring the Tx UE to apply the co-channel coexistence sidelink configuration, wherein configuring the Tx UE to apply the co-channel coexistence sidelink configuration includes configuring the Tx UE to identify that the sidelink resource of the first network at least partially overlaps the subframe of the sidelink resource of the second network.

Aspect 20: The method of Aspect 19, wherein configuring the Tx UE to identify that the sidelink resource of the first network at least partially overlaps the subframe of the sidelink resource of the second network includes configuring the Tx UE to determine whether the sidelink resource of the first network occurs during a first part of the subframe of the sidelink resource of the second network or a second part of the subframe of the sidelink resource of the second network.

Aspect 21: The method of Aspect 20, wherein configuring the Tx UE to identify that the sidelink resource of the first network at least partially overlaps the subframe of the sidelink resource of the second network includes configuring the Tx UE to set a first bit indicating that the sidelink resource of the first network occurs during the first part of the subframe of the sidelink resource of the second network or set a second bit indicating that the sidelink resource of the first network occurs during the second part of the subframe of the sidelink resource of the second network.

Aspect 22: The method of Aspect 20, wherein configuring the Tx UE to identify that the sidelink resource of the first network at least partially overlaps the subframe of the sidelink resource of the second network includes configuring the Tx UE to assign the sidelink resource of the first network to a first set of resources as a result of the Tx UE determining that the sidelink resource of the first network occurs during the first part of the subframe of the sidelink resource of the second network or assign the sidelink resource of the first network to a second set of resources as a result of the Tx UE determining that the sidelink resource of the first network occurs during the second part of the subframe of the sidelink resource of the second network.

Aspect 23: The method of Aspect 20, wherein configuring the Tx UE to identify that the sidelink resource of the first network at least partially overlaps the subframe of the sidelink resource of the second network includes configuring the Tx UE to assign the sidelink resource of the first network to a first set of resources as a result of the Tx UE determining that the sidelink resource of the first network is among a contiguous set of sidelink resources relative to a reference resource that occurs during the first part of the subframe of the sidelink resource of the second network or assign the sidelink resource of the first network to a second set of resources as a result of the Tx UE determining that the sidelink resource of the first network is not among a contiguous set of sidelink resources relative to a reference resource that occurs during the first part of the subframe of the sidelink resource of the second network.

Aspect 24: The method of any of Aspects 17-23, further comprising configuring the Tx UE to apply the co-channel coexistence sidelink configuration, wherein configuring the Tx UE to apply the co-channel coexistence sidelink configuration includes configuring the Tx UE to select the sidelink resource of the first network based, at least in part, on the sidelink resource of the first network occurring during the first part of the subframe of the sidelink resource of the second network.

Aspect 25: The method of any of Aspects 17-24, further comprising configuring the UE to apply the co-channel coexistence sidelink configuration, wherein configuring the Tx UE to apply the co-channel coexistence sidelink configuration includes configuring the Tx UE to select the sidelink resource of the first network based, at least in part, on the sidelink resource of the first network occurring during the first part of the subframe of the sidelink resource of the second network or the sidelink resource of the first network being among a contiguous set of sidelink resources relative to a reference resource that occurs during the first part of the subframe of the sidelink resource of the second network.

Aspect 26: The method of Aspect 25, wherein configuring the Tx UE to select the sidelink resource of the first network based, at least in part, on the sidelink resource of the first network being among the contiguous set of sidelink resources relative to the reference resource that occurs during the first part of the subframe of the sidelink resource of the second network includes configuring the Tx UE to select a physical slot associated with the sidelink resource of the first network among the contiguous set of sidelink resources for retransmission.

Aspect 27: The method of Aspect 25, wherein configuring the Tx UE to select the sidelink resource of the first network based, at least in part, on the sidelink resource of the first network being among the contiguous set of sidelink resources relative to the reference resource that occurs during the first part of the subframe of the sidelink resource of the second network includes configuring the Tx UE to schedule a transmission of a first packet during a first slot and schedule a transmission of a second packet during a second slot, the second slot being part of a same subframe of the first network as the first slot.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting user equipment (UE) (Tx UE) for wireless communication, comprising:
one or more memories; and
one or more processors, coupled to the one or more memories, configured to:
receive a co-channel coexistence sidelink configuration for identifying and selecting a sidelink resource of a first network based, at least in part, on whether the sidelink resource of the first network occurs during a subframe of a sidelink resource of a second network; and
transmit a sidelink message to a receiving UE in accordance with the co-channel coexistence sidelink configuration.

2. The Tx UE of claim 1, wherein the first network is associated with a first numerology and the second network is associated with a second numerology different from the first numerology.

3. The Tx UE of claim 1, wherein the one or more processors are configured to apply the co-channel coexistence sidelink configuration, wherein applying the co-channel coexistence sidelink configuration includes identifying that the sidelink resource of the first network at least partially overlaps the subframe of the sidelink resource of the second network.

4. The Tx UE of claim 3, wherein the one or more processors, to identify that the sidelink resource of the first network at least partially overlaps the subframe of the sidelink resource of the second network, are configured to determine that the sidelink resource of the first network occurs during a first part or a second part of the subframe of the sidelink resource of the second network.

5. The Tx UE of claim 4, wherein the one or more processors, to identify that the sidelink resource of the first network at least partially overlaps the subframe of the sidelink resource of the second network, are configured to set a first bit indicating that the sidelink resource of the first network occurs during the first part of the subframe of the sidelink resource of the second network, or setting a second bit indicating that the sidelink resource of the first network occurs during the second part of the subframe of the sidelink resource of the second network.

6. The Tx UE of claim 4, wherein the one or more processors, to identify that the sidelink resource of the first network at least partially overlaps the subframe of the sidelink resource of the second network, are configured to assign the sidelink resource of the first network to a first set of resources as a result of determining that the sidelink resource of the first network occurs during a first part of the subframe of the sidelink resource of the second network, or assigning the sidelink resource of the first network to a second set of resources as a result of determining that the sidelink resource of the first network occurs during a second part of the subframe of the sidelink resource of the second network.

7. The Tx UE of claim 4, wherein the one or more processors, to identify that the sidelink resource of the first network at least partially overlaps the subframe of the sidelink resource of the second network, are configured to assign the sidelink resource of the first network to a first set of resources as a result of determining that the sidelink resource of the first network is among a contiguous set of sidelink resources relative to a reference resource that occurs during a first part of the subframe of the sidelink resource of the second network, or assigning the sidelink resource of the first network to a second set of resources as a result of determining that the sidelink resource of the first network is not among a contiguous set of sidelink resources relative to a reference resource that occurs during the first part of the subframe of the sidelink resource of the second network.

8. The Tx UE of claim 7, wherein the one or more processors, to determine that the sidelink resource of the first network is among the contiguous set of sidelink resources relative to the reference resource, are configured to determine that the sidelink resource of the first network occurs within a first time window associated with the contiguous set of sidelink resources, the first time window beginning with the reference resource.

9. The Tx UE of claim 8, wherein the one or more processors, to determine that the sidelink resource of the first network is among the contiguous set of sidelink resources relative to the reference resource, are configured to after an expiry of the first time window, receiving a second time window associated with a different reference resource and a different contiguous set of sidelink resources relative to the different reference resource.

10. The Tx UE of claim 4, wherein the one or more processors, to determine whether the sidelink resource of the first network occurs during the first part of the subframe of the sidelink resource of the second network or the second part of the subframe of the sidelink resource of the second network, are configured to determine whether the sidelink resource of the first network occurs during the first part of the subframe of the sidelink resource of the second network or the second part of the subframe of the sidelink resource of the second network based, at least in part, on a slot bit map for a resource pool.

11. The Tx UE of claim 1, wherein the one or more processors are configured to apply the co-channel coexistence sidelink configuration, wherein applying the co-channel coexistence sidelink configuration includes selecting, via a medium access control (MAC) layer, the sidelink resource of the first network based, at least in part, on the sidelink resource of the first network occurring during a first part of the subframe of the sidelink resource of the second network.

12. The Tx UE of claim 1, wherein the one or more processors are configured to apply the co-channel coexistence sidelink configuration, wherein applying the co-channel coexistence sidelink configuration includes selecting, via a medium access control (MAC) layer, the sidelink resource of the first network based, at least in part, on the sidelink resource of the first network occurring during a first part of the subframe of the sidelink resource of the second network, or the sidelink resource of the first network being among a contiguous set of sidelink resources relative to a reference resource that occurs during the first part of the subframe of the sidelink resource of the second network.

13. The Tx UE of claim 12, wherein the one or more processors, to select the sidelink resource of the first network based, at least in part, on the sidelink resource of the first network being among the contiguous set of sidelink resources relative to the reference resource that occurs during the first part of the subframe of the sidelink resource of the second network, are configured to select a physical slot associated with the sidelink resource of the first network from among the contiguous set of sidelink resources for retransmission.

14. The Tx UE of claim 12, wherein the one or more processors, to select the sidelink resource of the first network based, at least in part, on the sidelink resource of the first network being among the contiguous set of sidelink resources relative to the reference resource that occurs during the first part of the subframe of the sidelink resource of the second network, are configured to schedule a transmission of a first packet during a first slot and scheduling a transmission of a second packet during a second slot, the second slot being part of a same subframe of the first network as the first slot.

15. A network node for wireless communication, comprising:
one or more memories; and
one or more processors, coupled to the one or more memories, configured to:
transmit a co-channel coexistence sidelink configuration for configuring a transmitting user equipment (UE) (Tx UE) to identify and select a sidelink resource of a first network based, at least in part, on whether the sidelink resource of the first network occurs during a subframe of a sidelink resource of a second network; and
configure the Tx UE to transmit a sidelink message to a receiving UE in accordance with the co-channel coexistence sidelink configuration.

16. The network node of claim 15, wherein the first network is associated with a first numerology and the second network is associated with a second numerology different from the first numerology.

17. The network node of claim 15, wherein the one or more processors are configured to configure the Tx UE to apply the co-channel coexistence sidelink configuration, wherein configuring the Tx UE to apply the co-channel coexistence sidelink configuration includes configuring the Tx UE to identify that the sidelink resource of the first network at least partially overlaps the subframe of the sidelink resource of the second network.

18. The network node of claim 15, wherein the one or more processors are configured to configure the Tx UE to apply the co-channel coexistence sidelink configuration, wherein configuring the Tx UE to apply the co-channel coexistence sidelink configuration includes configuring the Tx UE to select the sidelink resource of the first network based, at least in part, on the sidelink resource of the first network occurring during a first part of the subframe of the sidelink resource of the second network.

19. The network node of claim 15, wherein the one or more processors are configured to configure the Tx UE to apply the co-channel coexistence sidelink configuration, wherein configuring the Tx UE to apply the co-channel coexistence sidelink configuration includes configuring the Tx UE to select the sidelink resource of the first network based, at least in part, on the sidelink resource of the first network occurring during a first part of the subframe of the sidelink resource of the second network or the sidelink resource of the first network being among a contiguous set of sidelink resources relative to a reference resource that occurs during the first part of the subframe of the sidelink resource of the second network.

20. A method of wireless communication performed by a transmitting user equipment (UE) (Tx UE), comprising:
receiving a co-channel coexistence sidelink configuration for identifying and selecting a sidelink resource of a first network based, at least in part, on whether the sidelink resource of the first network occurs during a subframe of a sidelink resource of a second network; and
transmitting a sidelink message to a receiving UE in accordance with the co-channel coexistence sidelink configuration.
